(19) United States
(12) Patent Application Publication
(10) Pub. No.: US 2024/0420305 A1
(43) Pub. Date: Dec. 19, 2024

(54) AUTOMATED INSPECTION SYSTEM

(71) Applicant: ZETA MOTION LTD., Fleet, Hampshire (GB)

(72) Inventor: Wilhelm E. J. Klein, Castell (DE)

(73) Assignee: ZETA MOTION LTD., Fleet, Hampshire (GB)

(21) Appl. No.: 18/720,492

(22) PCT Filed: Dec. 19, 2022
(86) PCT No.: PCT/GB2022/053297

§ 371 Date: Jun. 14, 2024

(30) Foreign Application Priority Data
Dec. 17, 2021 (GB) 2118453.6

(51) Int. Cl. G06T 7/00; G05B 19/418

(52) U.S. Cl. CPC G06T 7/0004; G05B 19/41875; G06T 2207/10044; G06T 2207/10116; G06T 2207/10132; G06T 2207/20081; G06T 2207/20084; G06T 2207/30164

(57) ABSTRACT

A method of performing quality assessment in a process of manufacture of or processing of a product is provided. The method comprises: providing a specification (500) for the product, generating, from the specification, synthetic data (400) representative of the appearance of the product when conforming to the specification and, separately, the appearance of the product when defective. An Al model can be trained (420) using the synthetic data to distinguish between acceptable products and defective products, for use of the trained Al model on images of real products in a manufacturing or processing facility (450). On-line and off-line inspection systems are described. A sensor (115) captures raw data about an object and this, in conjunction with the trained Al model allows the system to distinguish between acceptable objects and defective objects, and to perform other tasks such as measuring.

### FIELD OF THE INVENTION

This invention relates to an artificial intelligence (AI) system, which is capable of locating, measuring, and/or detecting anomalies in an object in 3D space. It particularly relates to an adaptive automated surface inspection system (AASIS), but is not limited to surface inspection.

### BACKGROUND

Quality control in manufacturing often involves inspecting products and machinery for a number of defects such as incorrect dimensions, missing or out of place details, incorrect colours, scratches, cracks, contaminations, etc. This step is often referred to as conformance testing.

Conformance testing can be carried out at various stages of production, and such testing is typically classified into on-line and off-line categories. Off-line inspection is performed at the end of a production line, where products have already been assembled and have arrived at their final forms. At this point, the products are taken off the production line and inspected in a separate manner. This type of inspection is easier to carry out since products can be examined discretely by human inspectors and multiple attributes can be taken into account at once. The disadvantage of this method is that defects can only be discovered when the products are already finished, and thus products have to be discarded. Delays in finding the defects mean that a large quantity of materials is wasted. Additionally, off-line inspection often happens at set time intervals (e.g. every 15 minutes a quality inspector will pull an item off the production line and test it), resulting in significant possible delays between the occurrence of an error and the ability to identify the error and address it.

On-line inspection is performed at intermediate stages of production. Most frequently, it is more difficult for human inspectors to carry out this type of inspection because products are being moved on conveyor belts or similar automated systems—and are often inaccessible. For some production lines, intermediate stages can involve processing products at extreme temperatures or using chemicals that are dangerous. Consequently, on-line inspection is often performed by automated systems, which utilise various types of sensors and software to inspect products and objects.

Existing automated systems are limited by high cost, rigidity, and scalability.

Some automated systems rely on sophisticated but expensive hardware setup to achieve target accuracy and latency. They commonly involve multiple sensor systems such as laser profilers, radars, depth sensors, ultrasonic sensors, etc., to take advantage of individual systems.

Some automated systems are designed to specifically inspect a fixed set of attributes for a particular product and cannot be reconfigured to inspect other products. This causes the systems to become obsolete when the users change their products or add new products to the system. In parallel, modern manufacturing methodologies, such as agile manufacturing, require manufacturers to rapidly prototype and role out new products at increased frequencies, which pose an even greater challenge to conventional quality control systems.

Some automated systems utilise computer vision and artificial intelligence techniques to inspect products and machinery, which offer greater flexibility and configurability. However, these systems often require the users to collect a large amount of data for every object to be examined for training purposes, which is both time consuming and expensive. Most often, users are required to have expertise in artificial intelligence to be able to adequately prepare the data. For these reasons, existing computer vision-based systems cannot be rapidly scaled to different products, or production stages.

### SUMMARY OF THE INVENTION

According to a first aspect of the invention, a method of performing quality assessment in a process of manufacture of or processing of a product is provided. The method comprises: providing a specification for the product, generating, from the specification, synthetic data representative of the appearance of the product when conforming to the specification and, separately, the appearance of the product when defective and training an AI model using the synthetic data to distinguish between acceptable products and defective products, for use of the trained AI model on images of real products in a manufacturing or processing facility. The model is used at an inspection system by capturing images of real products and classifying them as acceptable or defective using the model. Information is fed back from the inspection system in the form of images of real products together with ground truth data identifying them as acceptable or defective, and using such data to further train the AI model.

In this way, synthetic data is used to “kick-start” training of the AI model and, through a feedback loop, the training keeps improving.

The images and ground truth data fed back to further train the AI model can be generated automatically, without further human input.

The arrangement is further advantageous because the real products may be products for which there is no specification available and/or no synthetic data.

For example, the model may first be trained on a first product using synthetic data representative of the appearance of the first product and later trained on a second product by identifying features of the second product using models of features extracted during training on the first product.

A major effort in training an AI model for inspection of products lies in identifying, to the AI model, what are the features of the product being inspected (and hence whether there are defects in relation to those features). By first training the model on synthetic data generated from a specification for a first product, the model can be used on a second product for with there is no synthetic data, because the model will have learned of the features of the first product and can apply its learning to the second product.

According to a second aspect of the invention, a system for assessing quality in a process of manufacture of or processing of a product is provided. The system comprises: means for receiving a specification for the product, means for generating, from the specification, synthetic data representative of the appearance of the product when conforming to the specification and, separately, the appearance of the product when defective, a processor implementing an AI model, and means for training the model using the synthetic data to distinguish between acceptable products and defective products, whereby the trained AI model can be used on images of real products in a manufacturing or processing facility. Means are provided for further training the model using images of real products that have been subjected to inspection using the trained AI model at the manufacturing or processing facility, where the images are fed back to the AI model together with ground truth data identifying the images as acceptable or defective.

According to a third aspect of the invention, an on-line or off-line inspection system is provided comprising: at least one sensor, which captures raw data about an object; and at least one processor, which utilizes an AI model trained using synthetic data to distinguish between acceptable objects and defective objects, wherein the synthetic data is representative of the appearance of the object when conforming to a specification and, separately, the appearance of the object when defective.

These and other aspects and embodiments of the invention will now be described, by way of example, with reference to the accompanying drawings.

### BRIEF DESCRIPTION OF THE DRAWINGS

FIG. 1 illustrates an inspection apparatus for static or lower speed product imaging.

FIG. 2 illustrates an inspection apparatus for higher speed product imaging.

FIG. 3 is a block diagram illustrating operation of an AI engine, in accordance with various aspects of the present disclosure.

FIG. 4 is a block diagram illustrating operation of an AI engine in further detail, in accordance with various aspects of the present disclosure.

FIG. 5 is a block diagram illustrating details of one of the modules of FIG. 4.

FIG. 6 is an illustrative example of images stored in a training database for the purpose of bottle washing.

FIG. 7 is an illustrative example of 2-D images stored in a training database for the purpose of quality checking of print material.

FIGS. 8a, 8b and 8c are illustrative examples of versions of a further product undergoing inspection.

### DETAILED DESCRIPTION

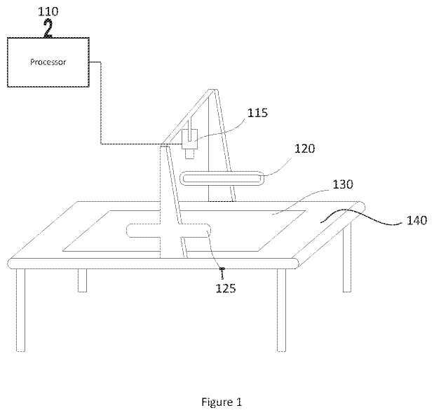

A generic inspection apparatus 100 is shown in FIG. 1. The apparatus 100 preferably comprises a conveyor 140, on which an object 130 is conveyed and a sensor 115. The conveyor 140 may alternatively take the form of a turntable or other mechanism designed to move the object across the sensor 115 field of vision. Alternatively, the sensor may be moved across the object. For smaller objects 130, the conveyor 150 may not be required, and a static surface may be used to hold the object 130 in view of the sensor 115, whereby the object 130 being imaged may be changed by hand.

A light source 120 may illuminate the object 130 and the conveyor for the benefit of the sensor 115 connected to the processor 110. This apparatus may generally be used for lower speed conveyor belts. Typically, the off-line system operates at low frequencies such as 1, 2, 3, 4, 5, 6, 7, 8 or 9 meters per minute.

The light source 120 may be used at a variety of angles to the object 130, including low angle, preferably less than 45 degrees, to help accentuate certain features of the object 130. This enables the sensor 115 to more easily detect certain features on the surface of the object 130, such as holes, bumps, and the like. The colour (wavelength) of the light source 120 may also be varied to accentuate other certain features of the object 130, such as colour, surface patterns, to overcome background light, and the like.

There are a variety of other lighting setups that may be desirable for certain applications, such as dark field illumination, telecentric illumination, backlights, frontlights, and spot lights.

The sensor 115 preferably comprises a camera capable of detecting visible light, but may be capable of detecting infra-red, ultra-violet light, and other detectable forms of electromagnetic radiation (e.g. X-rays). The sensor 115 may also comprise other sensing equipment to perform ultrasound measurements, or other sensing equipment that would suit a particular application. The processor 110 may process any input from sensor 115, and optionally be connected to a memory for purposes such as storing data, code, and the like.

The sensor 115 sends raw data such as grayscale image, RGB image, depth image, point clouds, range maps and other types of data, to the processor 110 for processing.

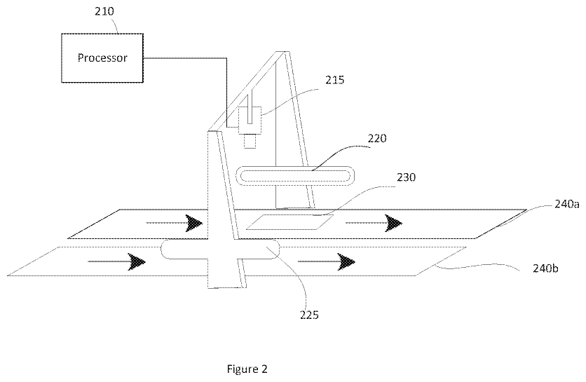

FIG. 2 displays a second generic inspection apparatus 200. This apparatus 200 may work much in the same way as apparatus 100, with the exception of having one or more higher speed conveyors 240a and 240b. In this way apparatus 200 is more suited to a higher throughput inspection line. Typically, the on-line system operates at very high frequencies such as 10, 100, 1000 or 1000 meters per minute.

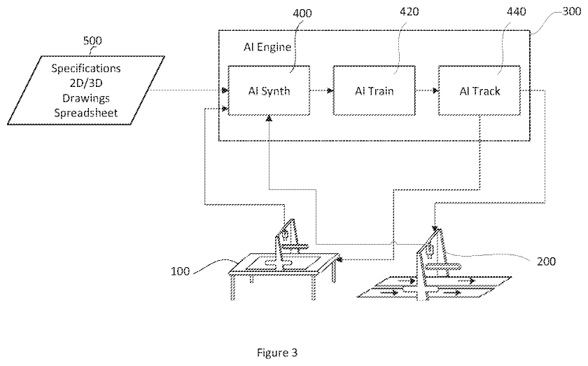

General operation of an AI engine 300 is shown in FIG. 3. This starts by providing the AI engine 300 with specifications 500 of a product. The AI engine 300 takes this input data 500, synthesizes training data through a module referred to as “AI Synth” 400, trains AI models from this training data through a module referred to as “AI Train” 420, and produces AI models ready for use on inspection systems through a module referred to as “AI Track” 440. The AI models so produced are then loaded into inspection apparatuses 100 and 200, which in turn can feed real data back into the AI engine 300 to enhance the training and produce more highly trained AI models, including models for additional products, e.g. products for which there is no specification and/or synthetic data.

Inspection systems apparatuses 100 and 200 are described in detail above. Specifications 500 and each module of AI engine 300 are described in detail below.

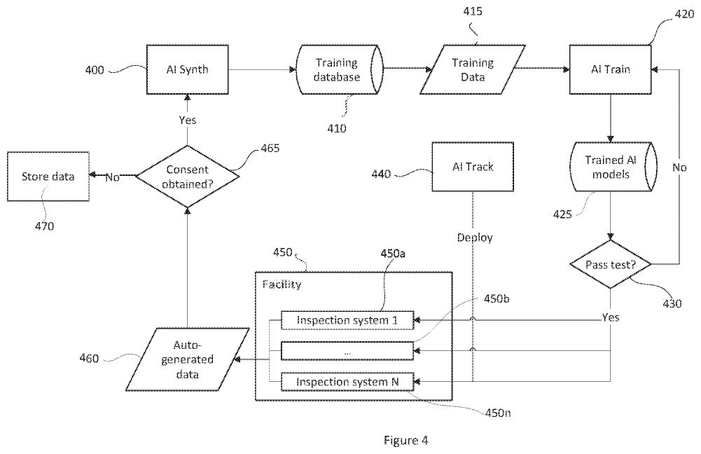

FIG. 4 shows a data synthesizing module referred to as “AI Synth” 400, described in more detail below, which generates a training database 410 comprising training data 415. This training data 415 is fed into a trainable AI module 420 referred to as “AI Train” to produce trained AI models 425. AI Train is preferably a computer-implemented neural network. AI Train generates a model for each product.

If a trained AI model 425 does not pass a quality test 430, the trained AI model 425 is re-trained by the AI Train module 420. If the trained AI models 425 pass, they can be loaded into an AI tracking module 440 referred to as “AI Track” and deployed to a manufacturing or processing facility 450. The facility 450 may comprise a plurality of production lines, each with its own inspection system 450a, 450b, . . . , 450n. The deployed trained AI models 425 create auto-generated data 460, which will either be stored in memory 470, or fed into AI Synth 400 to add to the training database 410. This may depend on whether consent is obtained 465 from the facility owner.

As a first example, this training database 410 may comprise many images of products such as wood panels, both with and without visible defects, each with an indicator of whether the image has a defect or not. Such training data 415 is used by AI Train 420 to produce trained AI models 425 capable of classifying images or parts of images as containing products (e.g. wood panels) with or without visible defects.

AI Train operates by performing feature extraction on the images provided by AI Synth, using standard techniques to identify features of interest and to build a model of the image in terms of such features. The model may comprise a set of feature identifiers (e.g. representing corners, dark circles that may be holes, short lengths of grain of different shapes and colour, sharp transitions that may be edges or scratches, etc.) The features are not pre-determined. I.e. it is not necessary to predefine a feature as “corner” or “hole”. Rather, the AI Train module itself coalesces on features of interest according to the images presented to it. The model may comprise locations (x and y or x, y and z) for the features, or locations relative to each other (in 2 or 3 dimensions), thereby modeling continuous edges or lines of grain etc. and joins and splits in grain and circular or rectangular components, etc. Where a product is presented as defective and a sharp transition is found in an otherwise continuous feature, this may be indicative of a defect. Similarly, where a product is presented as defective and a feature (which might, for example, be a component) is identified outside the location where it is found in products presented as non-defective, this may be indicative of a defect. By presenting many images represented as extracted feature models, the AI model of AI Train can be trained to identify defects.

Where a feature (e.g. an edge) is found in a location not specified by the specification or the synthetic data, the feature may nevertheless be recognized as such.

A feature (for example, a knot in the grain of a wooden board, or an edge of the board) is identified by the model. Where the feature is outside the location where it is found when the model is trained on synthetic data, this does not make it a defect. E.g. a knot or an edge is recognized as a knot/edge respectively.

As a further example, the product may be a mobile phone, e.g. a phone of a particular model (of which there are many in circulation). The features may be edges, a screen, a camera, a button, etc. Where an artifact (e.g. a sharp transition) is found in particular feature, such as a lens, this may be indicative of a defect. A similar artifact may not be a defect in another feature. E.g. a small scratch on a lens may be a defect where a similar sized scratch on a case may not. By training the model on synthetic data, the model is able to identify features and determine whether an artifact on that feature is a defect for that feature. Thus, each feature can have its own respective pass/fail criteria.

A feature (for example, a lens or other component) is identified by the model. Where the feature is outside the location where it is found when the model is trained on synthetic data, this may be because the product (phone) is of a model for which there is no specification and no synthetic data. Nevertheless, the feature is recognized. E.g. a lens (button, screen, edge etc) is recognized as such. By passing such products where they have no defects in their respective features, this information can be used to further train the AI model.

The trained AI models 425 are preferably also capable of performing measurements on images or extracted features to determine certain dimensions, locations, colours, patterns, holes, bumps, etc., of the product and any defects within the image.

The trained AI models may also produce quality scores based, at least in part, on these measurements where each measurement and score is available and associated with particular training data 415 within the training database 410.

For example, AI Train 420 may be trained to identify a defect and give a dimensionless score for that defect (e.g. on a scale of 1 to 10) and also give a measurement (e.g. the length in mm of a scratch). This feature is not limited to defects, but can apply to other features. E.g. the model may identify the dimensions of the product and deliver them as an output, or the position of a component, etc. If the measured quantity falls outside a tolerance for that measurement, it may register as a defect, but the measurement can be delivered even if it is within tolerance.

It will be understood that feature extraction can take place at an earlier stage in the process, and that the training database 410 may store representations of products in the form of feature models.

As a second example, the training database may comprise computer-generated images of a printed circuit board with components mounted thereon. As a third example, it may comprise images of products to be subject to a processing operation, e.g. bottles to be washed. As a fourth example it may comprise 2-D images of print material, e.g. magazines. These examples are detailed below.

To verify whether the trained AI models 425 are accurate enough to work in a facility, they must pass a test 430. The test 430 may comprise correctly classifying a certain percentage of images taken from the training database 410 as containing products (e.g. wood panels) either with or without visible defects. I.e. the test determines the level of false positive indications of a defect and, separately, the level of false negative indications of a defect. Thresholds for these measures are set and, if the test performs within these thresholds, the test is passed. If the test 430 is not passed, the trained AI models 425 are re-trained by AI Train 420 (with more data as necessary), and this loop repeats until they pass the test 430. (Alternatively, the sensitivity of the test can be reduced and the thresholds adjusted.) The thresholds (sensitivity) may be different for different features within a product.

Upon passing the test 430, the trained AI models 425 are stored in the form of the AI Track module 440 and deployed within the facility 450. AI track 440 may be stored in a local server at the facility 450 or may be loaded into firmware in each inspection system 450a, 450b, . . . , 450n.

The AI Track 440 module is a software module responsible for executing a trained AI model copied from the trained models 425 and ready to work on a moving production line—e.g. aiding the image capture of wood panels (or other products) passing along a conveyor belt under a camera as in FIG. 2.

In operation, an inspection system 450a captures images of products passing along its production line and AI Track module 440 performs feature extraction to extract features of interest from the images captured. During this process, the AI Track module 440 may also perform certain measurements as described above. It then operates as a classifier to classify the images, based on the features (and, optionally, measurements) extracted and the trained model and based on distance measurements between corresponding features extracted and modeled features to determine whether the real image is closer to (more like) a good product or a defective product. It accepts or rejects the product accordingly. Rejected products can be diverted off the production line to a reject hopper, manual inspection line or the like.

In the course of use of the deployed trained AI models 425, they auto-generate data 460, which may be images of wood panels (or other product) manually checked by a person to determine whether they contain a defect. These images may be fed into the AI Synth 400 to help expand the training database 410.

Considering the case where a feature such as an edge, for example, falls outside the expected range. This may indicate a product of incorrect size (falling outside the specification) which may be rejected upon manual inspection. Alternatively, it may merely indicate a different size of product and may be passed upon manual inspection. In the first instance, the data fed back to the AI model reinforces the existing model. In the second case, the data fed back informs the AI model that there are products of a different size that are acceptable.

Manual inspection is not necessary. The AI track module 440 can be set to pass or fail products automatically. The ground truth data may be automatic in the sense that all products found to be acceptable are deemed acceptable and all that are found to be defective are deemed defective.

For example, the AI track module 440 may be set to pass products that have no defects in their respective features. This may be so even if the features are some distance from their expected locations as determined by the synthetic data.

In other words, the synthetic data can be used to train the model on features and defects in features, and the model can be further (and automatically) trained to find those features in a product for which there is no synthetic data and to pass or fail them when found.

For example, when inspecting mobile phones, a lens (or other feature) may be identified in an unexpected location but may be otherwise non-defective. This product may pass inspection, in which case the AI model learns that the lens may be in a different location. (It may, so to speak, develop a new model for that different phone, but this is not to say that there is necessarily a mapping of models-to-products.) In this way, the model is trained on products for which there may not initially be a specification and synthetic data available. It is not necessary to provide a specification for the second product, as the AI model will simply learn that the dimensions and layout of the new product are acceptable.

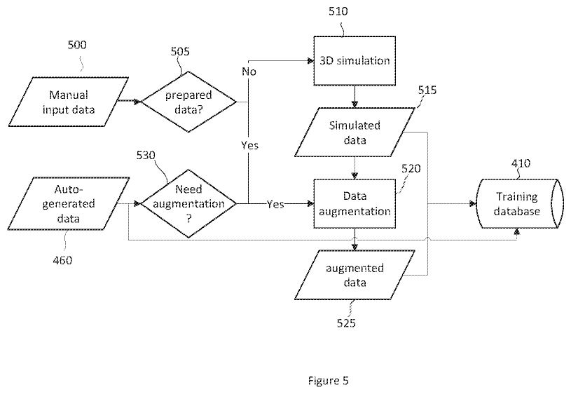

The module referred to as “AI Synth” 400 is shown in FIG. 5. Manual input data 500 is given to AI Synth 400, and if it is prepared data 505 (i.e. comprising an image), it is passed through data augmentation 520 to create augmented data 525. This augmented data adds variation upon the manual input data 500 to further expand the training database 410. If the manual input data 500 was not prepared, then a 3D simulation 510 is rendered from the manual input data, which simulated data 515 can be taken from and added to the training database 410 as well as undergoing data augmentation 520. In the case of auto-generated data 460 being fed into AI Synth 400, this may also undergo data augmentation 520, or if it does not need augmentation 530, it can be directly added to the training database 410.

The manual input data 500 comprises the desired design specifications of a product to be manufactured or resulting from being subjected to a process (e.g. washing). In the wood panel example, it comprises dimensions (e.g. width and thickness, where length may be variable) plus dimensions of any tongue and groove. It also comprises suitable representations of surface pattern. These may take the form of 2-dimensional images (real or computer-generated) showing colour and colour distribution. Alternatively, colour and colour distribution may be defined in a manner by which a computer generated image of the desired product can be rendered. The data may include surface texture. This may take the form of cross-sectional images or may be defined in a number of ways such as peak-to-trough (or peak-to-average) height of grain, size and distribution of peaks, etc. The data, including the texture data, is provided in a manner that allows a computer generated 3D image of the product to be rendered (including its surface).

The data 500 also includes allowable variations (tolerances) from the desired specifications.

3D simulations 510 of products are rendered from the manual input data 500, and images of this rendering are used as simulated data 515. In addition, defects in the product are simulated in a random manner. E.g. small and large scratches are simulated as well as spots and streaks of dirt or colour mismatch. Thus, a set of synthetic training data is generated, with renderings of products that are “perfect” or “satisfactory” together with an indication that these are “good” and other renderings of the same products that show defects of different sizes and natures and indications that these are “bad”.

Additionally, or alternatively, synthetic training data is generated with predetermined modified dimensions. These facilitate matching of a given product with a rendering of the product from many renderings of the product with different dimensions. In this manner, a measured dimension can be delivered as an output.

As before, feature extraction can optionally be performed at this stage, such that the synthetic data is stored in the form of feature models.

It is also possible, indeed desirable, to have other categories such as “almost perfect” or “minor defect” for renderings of products to which very small scratches, spots or other minor defects have been added. These can permit different levels of quality to be set later in the process.

Once there is prepared data, or simulated data 515, they undergo data augmentation 520 to provide variation upon the simulated data (i.e. the images). Data augmentation increases the amount of data by adding slightly modified copies of the data. It has the effect of adding noise to the dimensions, surface pattern, surface texture, etc. The effect of adding noise is to simulate real-world inspection scenarios, e.g. caused by vibration. In addition, noise can be added to the colour, or the colour can be skewed in different ways. For example, the colours in some of the samples can be made more yellow to represent illumination in “warm” light rather than “bright white” light. Augmentation helps reduce over fitting when training the AI model.

In the case of components placed on a circuit board, the noise may represent tolerance in the dimensions and/or placement of each component.

The augmented data 525 is then added to the training database 410.

Data augmentation is preferably applied to the simulated images. I.e. additional images are created with the required variations and the augmented images are subjected to feature extraction. Preferably the images are stored as both images and feature models. Data augmentation can be applied to the feature models. This is useful for certain features that already exist in the feature space and can be augmented in the feature space (e.g. the colour of a feature). If a feature does not exist in the feature space (e.g. a scratch or a hole) it may be possible to add it in the feature space but it is generally preferable to augment it in the image space.

Auto-generated data 460 is added to the training database 410, and is checked as to whether it needs augmentation 530. The question to be considered is whether the data has been generated in such a pristine environment (bright light and noise free) that it needs augmenting for use in a wider set of conditions (or, conversely, has it been generated in imperfect conditions such that it is already noisy and/or whether further augmentation would risk diluting its value). The decision whether to augment the data can be an automated decision based on the quality of the data.

If the data does not need augmentation, it is added directly to the training database 410. Otherwise, the auto-generated data 460 is also passed through data augmentation 520 before becoming augmented data 525 and added to the training database 410.

The adaptive automated surface inspection system (AASIS) and method described may be used to inspect many types of objects for many types of purposes within a given setting. In manufacturing, ASSIS may also be used to inspect machinery for wear and tear. In a hospital, AASIS may be used to inspect disinfected tools or items as they roll off the disinfection system. Or a large, automated canteen may deploy AASIS to inspect dishes and utensils after being washed.

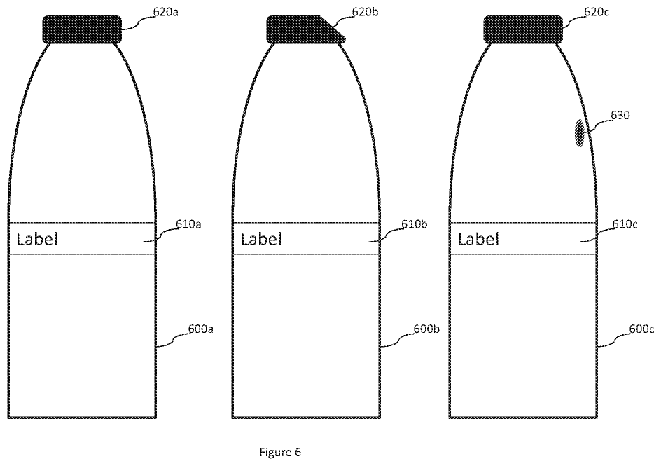

An example of the training database comprising images of bottles to be washed is illustrated in FIG. 6. Bottle 600a is an image of a new (undamaged and clean) bottle stored in memory 470. The image may be of a real bottle or may be an idealized image (e.g. computer-aided design image) of a bottle of a particular size and shape, with or without a label or surface decoration. In the example, the bottle has a label. It also has a cap 620a. There may be many different images of new bottles and a first step in the process may be to identify the particular design of bottle in question, leading to the selection of the image in FIG. 6a as being the image of the bottle that is to be processed.

Images 600b and 600c are synthetic versions of image 600a. They represent different types of defects that may be encountered before and/or after a washing cycle. Bottle cap 620b shows some part of the cap missing, which may represent damage from either before or during the washing process. Defect 630 on bottle 600c represents a possible stain or discolouring. Indeed this could be present before and/or after a washing cycle. The labels 610 (610a, 610b, 610c) may also have other defects e.g. position on the bottle, spelling errors, misprints. In such case, synthetic versions are created with all such defects. The labels 610 may be required to be removed before washing, in which case the label area can be a “don't care” area with no need to create synthetic versions of the image showing defects in that area. Such would be the case if the process involves putting on a new label after washing.

As described above, an AI model is trained on the synthetic versions of the image. It is trained with the knowledge of which images are perfect and which have had defects introduced. Optionally, many AI models are trained, one for each particular design of bottle In use, in which case a first step is to identify, using standard image recognition techniques, the design of bottle in question and to select the correct model for that design.

In use, a real bottle is imaged, e.g. after washing, and an image (or several images from different directions) is/are captured. This (or these) are compared with the model and classification is performed to identify features (e.g. cap, label, etc.) and classify the image as “good” (i.e. clean) or “defective”. In the case of “defective”, there may be several classifications such as “dirty” or “broken”. Thus, for example, a bottle that “matches” image 600b may be classified as “broken” or “broken cap”. Such a bottle may be reusable or not depending on the circumstances (e.g. the cap might be replaceable). A bottle that “matches” image 600c may be classified as “dirty”. Such a bottle may be re-useable (by re-washing or special hand treatment) or may be beyond the point where re-washing is likely to fix the defect.

Note that the term “match” here is used to denote usual classification techniques such as linear or other discriminant analysis. For example an image (or a feature in an image) may be attributed to a class by virtue of more closely matching a representation of that class than any other representation of any other class.

The process thus described with reference to FIG. 6 can be used in a medical setting for cleaning high-value bottles for reuse, or in a consumer setting for sorting and cleaning lower value bottles, or in a recycling process for sorting bottles that can be re-cycled (e.g. glass or PTFE) from those that are too highly contaminated to be re-cycled. It can be applied to other objects that are to be subjected to process steps, such as products that are to pass from one processing station to another. An example is tiles that are to be pressed and then fired and glazed and fired again. By applying the described process at each step, wastage can be avoided and defective products can be pulled out of the manufacturing line before the next processing step is applied.

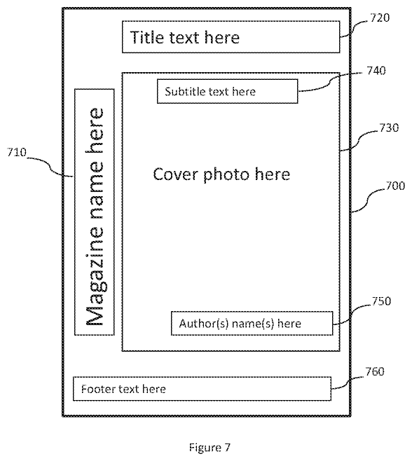

The example of the training database comprising 2-D images of print material is illustrated in FIG. 7. Image 700 represents the ideal specification for a possible magazine. The magazine 700 comprises zones for a magazine name 710, a title 720, a cover photo 730, a subtitle 740, author names 750, and a footer 760. Each of these may also have an associated font size, font type, maximum number of characters, colour, pattern, location, and area where they must be contained within, and tolerances for each. This is an example of a specification that may be used as manual input data (500).

Note that, in this example, there may be no real image of an actual ideal magazine. Rather, all the images in AI Synth 400 will be synthetic. Each “perfect” image is created by adding text of the correct font and size and by inserting images in the correct boxes. The synthetic text need not be real words in any language (but they could be). Incorrect versions are synthesized with text that is too large or too small and versions with text in the wrong place (e.g. overspilling its allocated field). Versions can also be created that have folds or improperly cut edges and the like.

Any magazine checked against this ideal specification may be classified as acceptable or defective, with measurements of each zone and non-dimensional scores for each zone available as outputs. The zones need not be pre-defined-they can be identified as features in an image of a magazine in the course of feature extraction performed on the image.

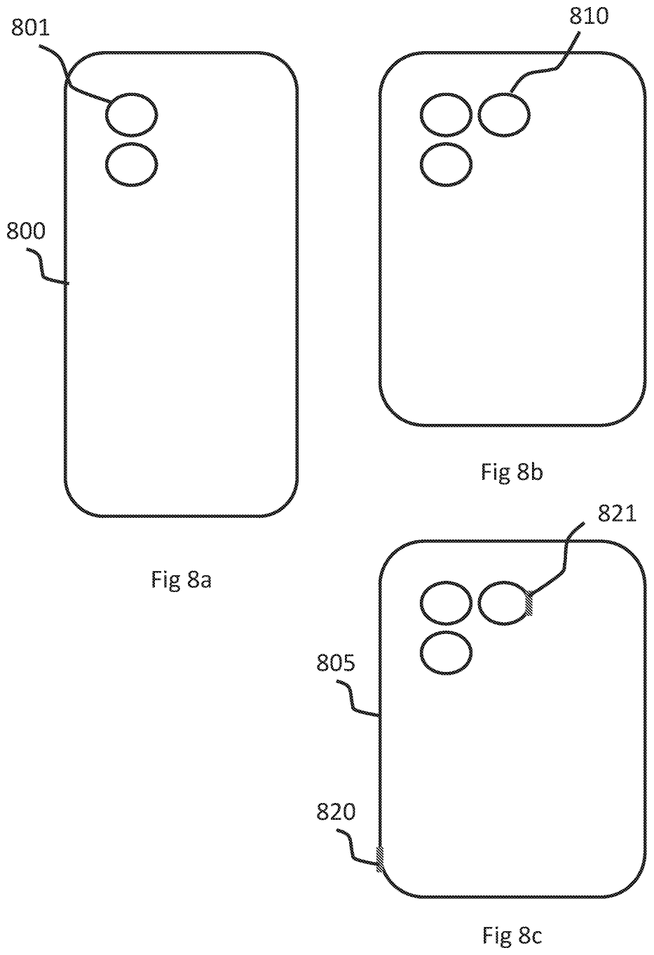

Referring to FIG. 8a, another example of a product is shown, in the form of a mobile phone 800. A rear side of the phone is shown (opposite side to the screen) but this is immaterial. The case will be considered where a specification for this product is available. It has a certain length and width and it has a lens 801 on in the top left corner (indeed it has a pair of lenses). An image as shown in FIG. 8a is generated in the AI Synth module 400 of FIG. 4 and an AI model is generated in AI Train module 420. AI models for the product are generated and are deployed on an inspection system 450a, as already described.

As before, defects in the phone 800 are simulated in a random manner. E.g. small and large scratches are simulated as well as spots and streaks of dirt or colour mismatch. In adding scratches, spots, streaks of dirt and the like, the training database 410 records whether these are “good” or “defective”. Different thresholds will result for different features. Thus, for example, a very small scratch in the area of the lens 801 is recorded in database 410 as a defect, where a scratch of the same size elsewhere on the cover of the phone is recorded as acceptable.

Thus (as previously described) a set of synthetic training data is generated, with renderings of products that are “perfect” or “satisfactory” together with an indication that these are “good” and other renderings of the same products that show defects of different sizes and natures and indications that these are “bad”.

In generating the models for the phone 800, AI Train “knows” that feature 801 is a lens. The feature is identified from the specification. (For example, in providing the specification, an operator can draw a boundary around that part of the image and label it “lens”).

The case will be considered now, where the inspection system 450a is presented with a phone as shown in FIG. 8b, which shows a phone 805 of a different model to phone 800. The case will be considered where there is no specification or synthetic data specifically relating to this model of phone 805. The system 450a is able to inspect this product without additional training.

Phone 805 has different dimensions. It is shorter. System 450a can identify its edges as features. It can apply the same inspection model for which it is already trained. Notwithstanding that the upper and lower edges are closer together than was the case with phone 800, it does not fail the product for this reason alone. This is because, in training the AI models by AI Train 425, a wide tolerance is given to the separation of certain features. Just as in the case of wood panels (which may be of different lengths and widths), so too the separation between features (e.g. edges) of a product such as a phone (or other product) can be given a wide tolerance.

Tolerance levels can be adjusted after training if necessary. For example, it may be that the tolerance for one or more dimensions (e.g. width) is narrow in AI Train 420, but that the deployed model is permitted to pass products even if they fail that particular test. In this way products can be passed that are similar but have a different width.

Additionally, through the same feature extraction as already described, system 450a can identify feature 810 of phone 805. It can identify the feature as a lens. It can apply the same inspection model for this lens as it did for the lens of product 800 for which it is already trained.

Referring now to FIG. 8c, a phone 806 is presented to the inspection system 450a, of the same model as phone 805. Phone 806 has two artifacts. It has an artifact 821 on the lens 810 and an artifact 820 on one of its edges. These artifacts are presented as being of similar size. They may be spots, scratches or the like. They are identified by system 450a. Artifact 820 falls within the acceptable tolerance for artifacts associated with the feature where it is located (edge). Artifact 821, by contrast, falls outside the acceptable tolerance for artifacts associated with the feature where it is located (lens). As a result, the phone 806 is rejected.

In this way, based on the features extracted and the trained model for phone 800, and based on distance measurements between corresponding features extracted and modeled features, a determination is made whether the real image is closer to (more like) a good product or a defective product. It is accepted or rejected accordingly. Rejected products can be diverted off the production line to a reject hopper, manual inspection line or the like as previously described. Images for the products that have passed inspection can be fed back to AI Synth 400 as previously described to improve the models in AI Train 420. Similarly, images for the products that have failed inspection can be fed back to AI Synth 400 as previously described to improve the models in AI Train 420. These can be fed back automatically without human input. Alternatively products (some or all) that have passed or failed can be subjected to manual inspection before feeding back.

According to another, independent aspect of the invention, a method of performing quality assessment in a process of manufacture of or processing of a product is provided. The method comprises: training an AI model (using real or synthetic data) to distinguish between acceptable products and defective products; using the trained AI model on images of real products in a manufacturing or processing facility by capturing images of real products; classifying them as acceptable or defective using the model; feeding back images of real products together with ground truth data identifying them as acceptable or defective; and using such data to further train the AI model. The ground truth data may be in the form of individual identifiers for individual products or may be automatic in the sense that all products found to be acceptable are deemed acceptable and all that are found to be defective are deemed defective. This latter case is useful in a scenario where the system is running satisfactorily and it has the advantage of providing real images into the training data (for example to replace or add to synthetic images). The real images can be augmented in the usual way or can negate the need for augmented images.

It may be noted that if a single product is removed by a human operator from the “accepted” output and passed to the “rejected” output, this indicates that all other products that are accepted are deemed accepted and all products that are rejected are deemed rejected. Similarly, if a single product is moved by a human operator from the “rejected” output to the “accepted” output, this indicates that all products that are accepted are deemed accepted and all other products that are rejected are deemed rejected.

It will be understood that embodiments of the present invention are described herein by way of example only, and that various changes and modifications may be made without departing from the scope of the invention.

It will be appreciated that aspects of the above described examples and embodiments can be combined to form further embodiments. For example, alternative embodiments may comprise one or more of the method of preparing synthesized training data, the method of training a model and the use of the deployed model as described in the above examples. Similarly, various features are described which may be exhibited by some embodiments and not by others. Yet further alternative embodiments may be envisaged, which nevertheless fall within the scope of the following claims.

1. A method of performing quality assessment in a process of manufacture of or processing of a product, comprising:
providing a specification for the product,
generating, from the specification, synthetic data representative of the appearance of the product when conforming to the specification and, separately, the appearance of the product when defective,
training an Al model using the synthetic data to distinguish between acceptable products and defective products, for use of the trained Al model on images of real products in a manufacturing or processing facility, further comprising using the model at an inspection system of the manufacturing or processing facility, by capturing images of real products and classifying them as acceptable or defective using the model, feeding back from the inspection system images of real products together with ground truth data identifying them as acceptable or defective, and using such data to further train the Al model.

2. The method of claim 1, further comprising measuring the accuracy of the model when trained on the synthetic data by testing the model against further synthetic data and, when an accuracy test is not passed, further training the model with further synthetic data.

3. The method of claim 1, further comprising measuring the accuracy of the model when trained on the synthetic data by testing the model against further synthetic data, and when the accuracy is passed, distributing the model to one or more manufacturing or processing facilities.

4. The method of claim 1, wherein the synthetic data represents a renderable ultrasound, radar or x-ray appearance of the product.

5. The method of claim 1, wherein the specification for the product comprises 2D and/or 3D technical drawings, technical specifications or images in any format.

6. The method of claim 1, further comprising augmenting the synthetic data to provide synthetic images of products in different simulated environments.

7. The method of claim 6, wherein the simulated environments have different lighting, noise, dust and/or vibration conditions.

8. The method according to claim 1 wherein the step of training an Al model comprises performing feature extraction on the synthetic data representative of acceptable and performing feature extraction on the synthetic data representative of defective products and generating and training the model in the feature domain.

9. The method of claim 1, further comprising training the model to measure an aspect of a product including one or more of a dimension, a location, a colour, a pattern, a hole, and a bump.

10. The method of claim 9 wherein the model provides, as an output, a quality score based at least in part on the measurement.

11. The method of claim 1, wherein the inspection system captures images of products and performs feature extraction to extract features of interest from the images captured.

12. The method of claim 1, wherein the real products include at least one product for which no specification has been provided.

13. The method of claim 1, wherein the model is first trained on a first product using synthetic data representative of the appearance of the first product and later trained on a second product by identifying features of the second product using models of features extracted during training on the first product.

14. The method of claim 1, wherein, in training the Al model to distinguish between acceptable products and defective products, respective features have respective tolerances.

15. A system for assessing quality in a process of manufacture of or processing of a product, comprising:
means for receiving a specification for the product,
means for generating, from the specification, synthetic data representative of the appearance of the product when conforming to the specification and, separately, the appearance of the product when defective,
a processor implementing an Al model,
means for training the Al model using the synthetic data to distinguish between acceptable products and defective products, whereby the trained Al model can be used on images of real products in a manufacturing or processing facility, and
means for further training the model using images of real products that have been subjected to inspection using the trained Al model at the manufacturing or processing facility, where the images are fed back to the Al model together with ground truth data identifying the images as acceptable or defective.

16. The system of claim 15, further comprising means for communicating with one or more manufacturing or processing facilities to send the model to the manufacturing or processing facility.
